(19) United States
(12) Patent Application Publication
(10) Pub. No.: US 2024/0081345 A1
(43) Pub. Date: Mar. 14, 2024

(54) Insecticide Compound and Container Device

(71) Applicants: Bianca Woodard, Riverview, FL (US); Joshua Caldwell, Riverview, FL (US)

(72) Inventors: Bianca Woodard, Riverview, FL (US); Joshua Caldwell, Riverview, FL (US)

(21) Appl. No.: 18/318,059

(22) Filed: May 16, 2023

Related U.S. Application Data
(60) Provisional application No. 63/405,604, filed on Sep. 12, 2022.

(51) Int. Cl. A01N 65/42; A01N 55/08; A01N 65/08; A01P 7/04

(52) U.S. Cl. CPC A01N 65/42; A01N 55/08; A01N 65/08; A01P 7/04

(57) ABSTRACT

The present invention relates to an insecticide compound and container device primarily comprised of at least one insecticide compound and at least one container that stores the compound while in use. The compound is preferably comprised of onion, flour, sugar, and boric acid that creates an insecticide that is not harmful to humans. The compound is stored within a base of the container. The container may be comprised of at least one fastener to allow the container to be secured to any surface in any location.

### CROSS-REFERENCE TO RELATED APPLICATION

The present application claims priority to, and the benefit of, U.S. Provisional Application No. 63/405,604, which was filed on Sep. 12, 2022, and is incorporated herein by reference in its entirety.

### FIELD OF THE INVENTION

The present invention relates generally to the field of insecticides. More specifically, the present invention relates to an insecticide compound and container device primarily comprised of at least one insecticide compound and at least one container that stores the compound while in use. The compound is preferably comprised of onion, flour, sugar, and boric acid that creates an insecticide that is not harmful to humans. The compound is stored within a base of the container. The container may be comprised of at least one fastener to allow the container to be secured to any surface in any location. Accordingly, the present disclosure makes specific reference thereto. Nonetheless, it is to be appreciated that aspects of the present invention are also equally applicable to other like applications, devices, and methods of manufacture.

### BACKGROUND

Areas such as homes, offices, schools, etc., may often experience cockroach infestations. In addition to being unsanitary, cockroach infestations are notoriously difficult to treat. Treating cockroach infestations are often treated with active treatment methods involving dangerous poisons and/or toxic chemicals applied by exterminators. This process can be extremely costly and may also cause nearby individuals, objects, or food to come in with the poison/chemicals causing potential serious injury or illness.

Therefore, there exists a long-felt need in the art for an improved insecticide. There also exists a long-felt need in the art for an insecticide compound and container device that does not contain any toxic chemicals or poisons that can injure humans. In addition, there exists a long-felt need in the art for an insecticide compound and container device that can be used to passively treat insect infestations. Furthermore, there exists a long-felt need in the art for an insecticide compound and container device that can be easily placed in a variety of locations.

The subject matter disclosed and claimed herein, in one embodiment thereof, comprises an insecticide compound and container device. The device is primarily comprised of at least one insecticide compound and at least one container that stores the compound while in use. The compound is preferably comprised of onion, flour, sugar, and boric acid that creates an insecticide that is not harmful to humans. The compound is stored within a base of the container. The lid of the container attaches to the base with reciprocating fasteners such that a gap is created to allow cockroaches and other insects to consume the compound. The compound and/or container may further be scented to increase attraction to insects. The container may be comprised of at least one fastener to allow the container to be secured to any surface in any location.

In this manner, the insecticide compound and container device of the present invention accomplishes all of the foregoing objectives and provides an improved insecticide that does not contain any toxic chemicals or poisons that can injure humans. The device can also be used to passively treat insect infestations. In addition, the device can be easily placed in a variety of locations within the container.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an insecticide compound and container device primarily comprised of at least one insecticide compound and at least one container that stores the compound while in use. The compound is preferably in the form of a solid but may also be in the form of a liquid or semi-solid in different embodiments. The compound is preferably comprised of a plurality of ingredients. Said ingredients include a first ingredient in the form of an onion, a second ingredient in the form of flour, a third ingredient in the form of sugar, and a fourth ingredient in the form of boric acid. In the preferred embodiment, the compound is comprised of one onion, one cup of flour, one cup of sugar, and 15 ounces of boric acid. The compound may be comprised of at least one scent and at least one flavoring that further entices insects to the compound. The compound fatally poisons insects such as, but not limited to, cockroaches.

In the preferred embodiment, the compound is a solid and is stored in at least one container during use. As a result, the container can be placed in areas of the home as needed, without requiring the user to apply the compound to any surface. In the preferred embodiment, the container is generally circular in shape. The container is comprised of a base, preferably comprised of a flat bottom wall. The flat bottom wall allows the container to sit on any surface. In one embodiment, the bottom wall is comprised of at least one rubber layer that is textured to prevent the container from moving. In one embodiment, the bottom wall may also be comprised of at least one fastener that allows the container to be attached to any surface in any orientation in a versatile manner.

The interior surface of the base is preferably concave in shape such that the compound cannot escape the base and is comprised of at least one fastener. The fastener of the interior surface is a reciprocating fastener located on a bottom surface of a lid. The fastener of the base is preferably of a height such that it extends above the base, such that a gap is created between the lid and base when the fasteners are used to attach the lid to the base. In this manner, insects can access and eat the compound within the base while the lid prevents nearby surfaces and/or objects from coming into contact with the compound. In one embodiment, the lid is comprised of at least one opening that further allows the scent of the compound to leave the container without allowing nearby surfaces and/or objects to come into contact with the compound.

Accordingly, the insecticide compound and container device of the present invention is particularly advantageous as it provides an improved insecticide. In doing so, the device provides an insecticide that does not contain any toxic chemicals or poisons that can injure humans. The device can also be used to passively treat insect infestations. In addition, the device can be easily placed in a variety of locations within the container. In this manner, the insecticide compound and container device overcomes the limitations of existing insecticides known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of components of a compound of one potential embodiment of an insecticide compound and container device of the present invention in accordance with the disclosed architecture;

FIG. 2 illustrates a perspective view of a container of one potential embodiment of an insecticide compound and container device of the present invention while assembled in accordance with the disclosed architecture; and

FIG. 3 illustrates a perspective view of a container of one potential embodiment of an insecticide compound and container device of the present invention while disassembled in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved insecticide. There also exists a long-felt need in the art for an insecticide compound and container device that does not contain any toxic chemicals or poisons that can injure humans. In addition, there exists a long-felt need in the art for an insecticide compound and container device that can be used to passively treat insect infestations. Furthermore, there exists a long-felt need in the art for an insecticide compound and container device that can be easily placed in a variety of locations.

The present invention, in one exemplary embodiment, is comprised of an insecticide compound and a container device. The device is primarily comprised of at least one insecticide compound. The device is also comprised of at least one container that stores the compound while in use. The compound is preferably in the form of a solid but may also be in the form of a liquid or semi-solid in different embodiments. The compound is preferably comprised of a plurality of ingredients including a first ingredient in the form of an onion, a second ingredient in the form of flour, a third ingredient in the form of sugar, and a fourth ingredient in the form of boric acid. In the preferred embodiment, the compound is comprised of one onion, one cup of flour, one cup of sugar, and 15 ounces of boric acid. The compound may be comprised of at least one scent and at least one flavoring that further entices insects to the compound. The compound fatally poisons insects such as, but not limited to, cockroaches.

The compound is preferably a solid that is stored in at least one container during use. During use, the container can be placed in areas of the home as needed without requiring the user to apply the compound to any surface. In the preferred embodiment, the container is generally circular in shape and is comprised of a base, preferably comprised of a flat bottom wall. The flat bottom wall allows the container to sit on any surface. The bottom wall may be comprised of at least one rubber layer that is textured to prevent the container from moving. In one embodiment, the bottom wall may also be comprised of at least one fastener that allows the container to be attached to any surface in any orientation in a versatile manner.

The interior surface of the base is preferably concave in shape, such that the compound cannot escape the base. The interior surface is comprised of at least one fastener. The fastener of the interior surface is a reciprocating fastener located on a bottom surface of a lid. The fastener of the base is preferably of a height such that it extends above the base such that a gap is created between the lid and base when the fasteners are used to attach the lid to the base. In this manner, insects can access and eat the compound within the base while the lid prevents nearby surfaces and/or objects from coming into contact with the compound. In one embodiment, the lid is comprised of at least one opening that further allows the scent of the compound to leave the container without allowing nearby surfaces and/or objects to come into contact with the compound.

Accordingly, the insecticide compound and container device of the present invention is particularly advantageous as it provides an improved insecticide. In doing so, the device provides an insecticide that does not contain any toxic chemicals or poisons that can injure humans. The device can also be used to passively treat insect infestations. In addition, the device can be easily placed in a variety of locations within the container. In this manner, the insecticide compound and container device overcomes the limitations of existing insecticides known in the art.

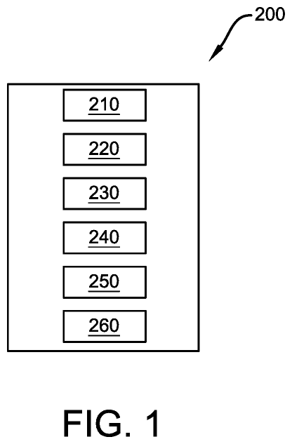

Referring initially to the drawings, FIG. 1 illustrates a graphical view of components of the compound 200 of one potential embodiment of an insecticide compound and container device 100 of the present invention in accordance with the disclosed architecture. The device 100 is primarily comprised of at least one insecticide compound 200 and at least one container 300 that stores the compound 200 while in use. The compound 200 is preferably in the form of a solid. However, the compound 200 may also be in the form of a liquid or semi-solid in different embodiments. The compound 200 is preferably comprised of a plurality of ingredients. Said ingredients include a first ingredient 200 in the form of an onion. The onion 200 may be any onion type known in the art such as, but not limited to, a yellow onion, a sweet onion, a white onion, a green onion, a shallot, or a leek. The second ingredient 220 is comprised of flour. The flour 220 may be any type known in the art such as, but not limited to, all-purpose flour, bread flour, whole wheat flour, white whole wheat flour, cake flour, etc. The third ingredient 230 is comprised of sugar. The sugar 230 may be any type known in the art such as, but not limited to, caster sugar, brown sugar, cane sugar, fruit sugar, granulated sugar, etc. The fourth ingredient 240 is comprised of boric acid. The compound 200 fatally poisons insects such as, but not limited to, cockroaches.

In the preferred embodiment, the compound 200 may be comprised of the ingredients 210,220,230,240 in any combination and amount. However, in the preferred embodiment, the compound 200 is comprised of one onion 210, one cup of flour 220, one cup of sugar 230, and 15 ounces of boric acid 240. It should be appreciated that these amounts and combinations can be scaled to produce more or less of the compound 200. In addition, the compound 200 may be comprised of at least one scent 250 and at least one flavoring 260 that further entices insects to the compound 200. The scent 250 may be any natural or artificial scent or a combination thereof. The flavoring 260 may be any natural or artificial flavoring or a combination thereof known in the art.

In the preferred embodiment, the compound 200 is a solid and is stored in at least one container 300 during use. In this manner, the container 300 can be placed in areas of the home as needed without requiring the user to apply the compound 200 to any surface.

The container 300 is preferably comprised of a rigid plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. In the preferred embodiment, the container 300 is generally circular in shape. However, the container 300 may be any shape known in the art in a different embodiment such as, but not limited to, square, triangular, etc.

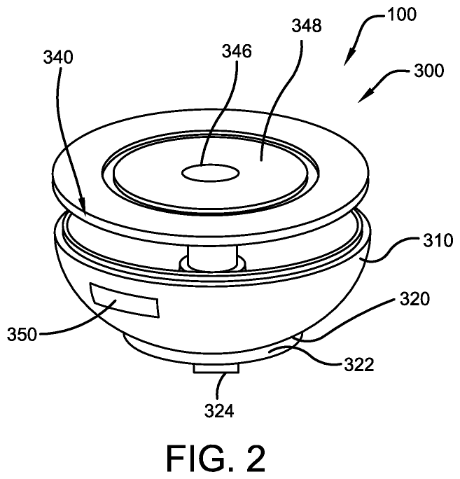

FIG. 2 illustrates a perspective view of a container 300 of one potential embodiment of an insecticide compound and container device 100 of the present invention while assembled in accordance with the disclosed architecture. The container 300 is comprised of a base 310. The base 310 is preferably comprised of a flat bottom wall 320. The flat bottom wall 320 allows the container 300 to sit on any surface. In one embodiment, the bottom wall 320 is comprised of at least one rubber layer 322. The rubber layer 322 is textured to prevent the container 300 from moving. In one embodiment, the bottom wall 320 may also be comprised of at least one fastener 324. The fastener 324 allows the container 300 to be attached to any surface in any orientation in a versatile manner. The fastener 324 may be any fastener known in the art such as, but not limited to, hook and loop, suction cup, adhesive, magnet, etc.

The interior surface 330 of the base 310 is preferably concave in shape such that compound 200 cannot escape the base 310. The interior surface 330 is comprised of at least one fastener 332. The fastener 332 is a reciprocating fastener of at least one fastener 344 located on a bottom surface 342 of a lid 340. The fastener 332 of the base 310 is preferably of a height such that it extends above the base 310. In this manner, once the lid 340 attaches to the fastener 332 via the lid reciprocating fastener 344 a gap is created between the lid 340 and base 310. In this manner, insects can access and eat the compound 200 within the base 310. The fasteners 332,344 may be any fastener type known in the art that attach to one another. The fasteners 332, 344 are preferably a male fastener 332 and a female fastener 344 and/or a magnetized male fastener 324 and a magnetized female fastener 332,344. The lid 340 prevents nearby surfaces and/or objects from coming into contact with the compound 200. In one embodiment, the lid 340 and base 310 may be fixedly connected. In another embodiment, the lid 340 may additionally or alternatively, be comprised of a fastener 332 on the outer surface 348 of the lid 340. In one embodiment, the compound 200 may be additionally or alternatively, stored on the bottom surface 342 of the lid 340 as a solid.

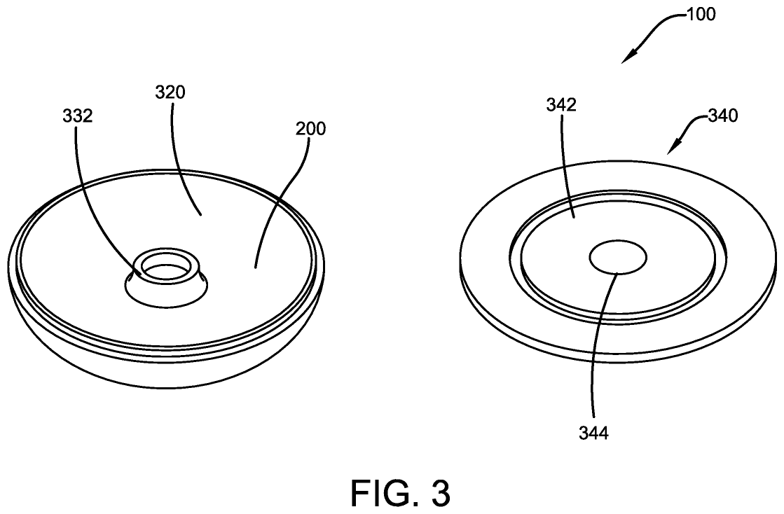

In one embodiment, the lid 340 is comprised of at least one opening 346 that further allows the scent of the compound 200 to leave the container 300 without allowing nearby surfaces and/or objects to come into contact with the compound 200, as seen in FIG. 3. In one embodiment, the container 300 itself may be comprised of a scented coating 350 that attracts insects. The coating 350 may be any natural or artificial scent or a combination thereof.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “insecticide compound and container device” and “device” are interchangeable and refer to the insecticide compound and container device 100 of the present invention.

Notwithstanding the foregoing, the insecticide compound and container device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the insecticide compound and container device 100 as shown in the FIGS. are for illustrative purposes only, and that many other sizes and shapes of the insecticide compound and container device 100 are well within the scope of the present disclosure. Although the dimensions of the insecticide compound and container device 100 are important design parameters for user convenience, the insecticide compound and container device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An insecticide compound and container device comprising:
a compound comprised of an amount of onion, an amount of flour, an amount of sugar, and an amount of boric acid; and
a container comprised of a base having a first fastener and a lid having a second fastener, wherein the compound is stored in the base.

2. The insecticide compound and container device of claim 1, wherein the amount of onion is comprised of a singular onion.

3. The insecticide compound and container device of claim 1, wherein the amount of flour is comprised of a cup of flour.

4. The insecticide compound and container device of claim 1, wherein the amount of sugar is comprised of a cup of sugar.

5. The insecticide compound and container device of claim 1, wherein the amount of boric acid is comprised of fifteen ounces of boric acid.

6. An insecticide compound and container device comprising:
a scented compound comprised of an amount of onion, an amount of flour, an amount of sugar, and an amount of boric acid; and
a container comprised of a base having a first fastener and a lid having a second fastener.

7. The insecticide compound and container device of claim 6, wherein the scented compound is comprised of a natural scent, an artificial scent, or a combination natural and artificial scent.

8. The insecticide compound and container device of claim 6, wherein the base is comprised of a second fastener on a bottom surface of the base.

9. The insecticide compound and container device of claim 6, wherein the lid is comprised of a fastener positioned on an outer surface of the lid.

10. The insecticide compound and container device of claim 6, wherein the compound is in a liquid form.

11. An insecticide compound and container device comprising:
a scented and flavored compound comprised of an amount of onion, an amount of flour, an amount of sugar, and an amount of boric acid; and
a scented container comprised of a base having a first fastener and a lid having a second fastener.

12. The insecticide compound and container device of claim 11, wherein the scented container is comprised of a natural scent, an artificial scent, or a combination natural and artificial scent.

13. The insecticide compound and container device of claim 11, wherein the scented container is comprised of a flat bottom surface.

14. The insecticide compound and container device of claim 13, wherein the flat bottom surface is comprised of a textured rubber material.

15. The insecticide compound and container device of claim 11, wherein the second fastener attaches to the first fastener.

16. The insecticide compound and container device of claim 11, wherein the compound is stored within the base.

17. The insecticide compound and container device of claim 11, wherein the base is comprised of a concave shape.

18. The insecticide compound and container device of claim 11, wherein the compound is in a solid form.

19. The insecticide compound and container device of claim 11, wherein the lid is comprised of an opening.

20. The insecticide compound and container device of claim 11, wherein the first fastener is greater in height than the base.
